(19) United States
(12) Patent Application Publication
(10) Pub. No.: US 2004/0252050 A1
(43) Pub. Date: Dec. 16, 2004

(54) Vehicle fleet navigation system

(76) Inventors: Steven C. Tengler, Grosse Point Park, MI (US); John P. Weiss, Macomb, MI (US); Richard C. Berry, West Bloomfield, MI (US)

Correspondence Address: MACMILLAN, SOBANSKI & TODD, LLC, ONE MARITIME PLAZA-FOURTH FLOOR, 720 WATER STREET, TOLEDO, OH, 43604, US

(21) Appl. No.: 10/462,544

(22) Filed: Jun. 16, 2003

(51) Int. Cl. G01S 5/14

(52) U.S. Cl. 342/357.08

(57) ABSTRACT

A vehicle fleet navigation system includes a main mobile navigation system, at least one secondary mobile navigation system, and a land based navigation system. The main mobile navigation system includes a navigation unit for determining the position of the main vehicle, a visual display for displaying the position of the main vehicle, and a wireless transceiver in communication with the navigation unit. The secondary system includes a second navigation unit for determining the position of the second vehicle, and a second wireless transceiver in communication with the second navigation unit. The second wireless transceiver is operable to transmit a position signal corresponding to positional information of the second vehicle received from the second navigation unit. The main mobile navigation system is operable to receive the positional information of the second vehicle and display the position of the second vehicle on the visual display. The land based navigation system is in communication with one of the main mobile navigation system and the secondary mobile navigation system to receive the positional information of the second vehicle. The land based navigation system includes a visual display for displaying the position of the second vehicle.

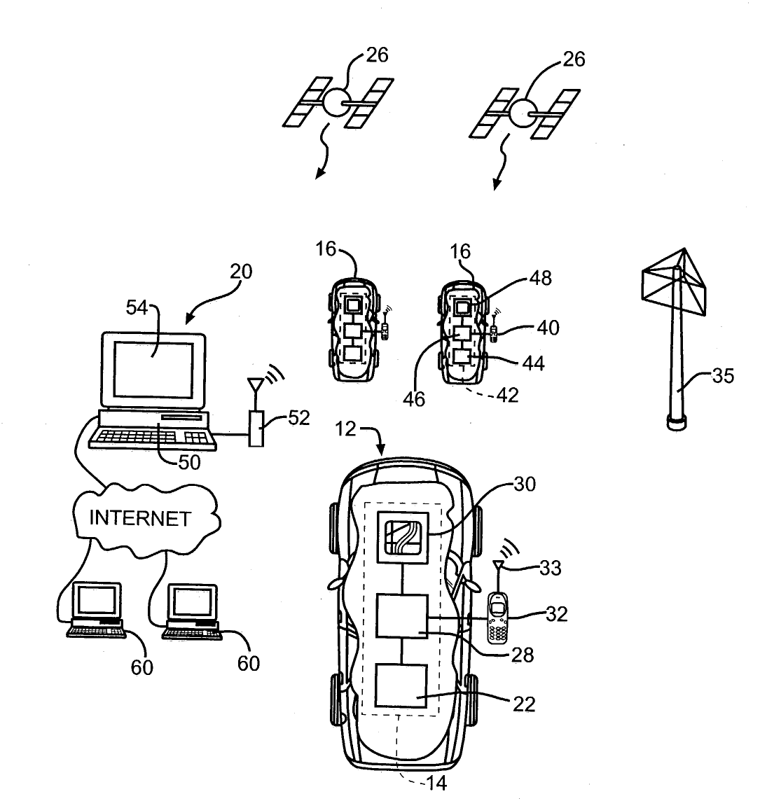

### BACKGROUND OF THE INVENTION

This invention relates in general to navigation systems, and in particular to vehicle fleet navigation systems.

Vehicle fleet navigation systems are commonly used in service industries in which it is desirable to know the location of a plurality of vehicles, such as taxis, shipping vehicles, and emergency vehicles. Typically, these vehicle fleet navigation systems include a land based central dispatch or base station. The base station is in communication with the vehicles via a wireless transmitter system installed in each of the vehicles. The wireless systems transmit a unique vehicle identification code along with positional information to the base station. The positional information corresponds to the geographical position of that particular vehicle. Commonly, the base station includes a display device which displays the position of the vehicle relative to a pictorial map. The base station monitors the transmissions of the plurality of vehicles to track and monitor the positions of all the vehicles relative to one another. Although this system is useful for monitoring the position of the vehicles from a land based system, the drivers of the plurality of vehicles do not receive positional information of the other vehicles. This information is often useful for the drivers of the vehicles.

It is also known to include navigation systems, such as a conventionally known global positioning system (GPS), in individual vehicles. GPS systems include a receiver unit for receiving signals from a plurality of GPS satellites. The navigational system includes a signal processor which computes the position of the vehicle in coordinates determined from the plurality of satellite signals. The coordinates can be used to plot the position of the vehicle onto a graphical or pictorial map shown on a display. The map may include roadway or geographical data along with a graphical symbol designating the position of the vehicle relative to the highway and/or geographical data on the display. Although the use of a GPS system is helpful for the driver of the vehicle, the conventional GPS systems do not relate information regarding positions of other vehicles which may be of interest to the driver.

### BRIEF SUMMARY OF THE INVENTION

This invention relates to a vehicle fleet navigation system including a main mobile navigation system, at least one secondary mobile navigation system, and a land based navigation system. The main mobile navigation system includes a navigation unit for determining the position of the main vehicle, a visual display for displaying the position of the main vehicle, and a wireless transceiver in communication with the navigation unit. The secondary system includes a second navigation unit for determining the position of the second vehicle, and a second wireless transceiver in communication with the second navigation unit. The second wireless transceiver is operable to transmit a position signal corresponding to positional information of the second vehicle received from the second navigation unit. The main mobile navigation system is operable to receive the positional information of the second vehicle and display the position of the second vehicle on the visual display. The land based navigation system is in communication with one of the main mobile navigation system and the secondary mobile navigation system to receive the positional information of the second vehicle. The land based navigation system includes a visual display for displaying the position of the second vehicle.

Various objects and advantages of this invention will become apparent to those skilled in the art from the following detailed description of the preferred embodiment, when read in light of the accompanying drawings.

### BRIEF DESCRIPTION OF THE DRAWINGS

The FIGURE is a schematic representation of a vehicle fleet navigational system in accordance with the present invention.

### DETAILED DESCRIPTION OF THE INVENTION

Referring now to the drawings, there is illustrated in the FIGURE, a vehicle fleet navigational system, indicated generally at 10. The vehicle fleet navigational system 10 preferably includes an ownship or main vehicle 12 having a main mobile navigation system 14 for tacking the position of one or more second or auxiliary vehicles 16. Preferably, the system 10 also includes a land based navigation system 20 for tracking at least the auxiliary vehicles 16. The land based navigation system 20 may also track the position of the main vehicle 12. As will be explained in detail below, the land based navigation system 20, the main vehicle 12, and the auxiliary vehicles 16 are preferably in selective communication with each other to exchange the positional location of at least the auxiliary vehicles 16, and optionally the main vehicle 12. As will also be explained in detail below, a preferred embodiment of the system 10 uses navigational units, such as GPS units, in the vehicles used in conjunction with a wireless data connection, such as a cellular phone network, to communicate with one another for tracking the position of the vehicles. Preferably, a plurality of signals are transmitted at spaced apart time intervals to update the positional information of the vehicles. The time intervals can be equally spaced apart and/or can be transmitted upon the occurrence of an event, such as a request by the main vehicle 12 or the land based navigation system 20 to update the positional information.

The system 10 is ideally configured for a vehicle fleet navigation system in which a supervisor, manager, or fleet owner is operating the main vehicle 12 and desires to keep track of the location of the auxiliary vehicles 16 on its own navigation unit. The auxiliary vehicles 16 may optionally also have navigational display units which track the location of their vehicle along with other auxiliary vehicles and/or the main vehicle. The land based navigation system 20 may be used by a dispatch or coordinator station for also tracking the location of the vehicles 12 and 16.

Preferably, the main mobile navigation system 14 is installed in the vehicle 12. Alternatively, the navigation system 14 may be a portable self powered system, such as a handheld unit. The navigation system 14 preferably includes a navigation receiving unit 22 for detecting the location of the main vehicle. However, it should be understood that the main mobile navigation system 14 need not include the navigation receiving unit 22 and may instead only include navigational display equipment for tracking the auxiliary vehicles 12.

The navigation receiving unit 22 can be any suitable apparatus capable of determining the position of the main vehicle 12. An example of a suitable navigation unit 22 is a GPS navigational unit which receives signals from a plurality of GPS satellites 26 to determine the position of the main vehicle 12. The navigation system 14 also includes a controller 28, such as a microprocessor, which is in communication with the navigational receiving unit 22. Upon receiving the satellite signals from the satellites 26 via an antenna, the navigational receiving unit 22 and/or the controller 28 computes the position of the main vehicle 12 in accordance with the received signals. The coordinates are compared to map data stored in the controller 28 and transmitted to a display 30 for displaying the position of the main vehicle 12 as a symbol or numerical coordinates (such as longitude and latitude). Preferably, the display 30 is capable of displaying the position of the main vehicle 12 as a symbol overlaid onto a geographical and/or roadway pictorial map corresponding to the internally stored map data. Map data may also be accessed through storage media, such as a compact disc or other suitable storage devices. The display 30 can be any suitable apparatus, such as an LCD, CRT, EL, or LCD display, for displaying positional information, such as numerical coordinates or more preferably a pictorial map.

The main vehicle 12 of the system 10 is preferably equipped with a transceiver 32 having an antenna 33 for transmitting and receiving wireless signals, the reason for which will be explained in detail below. Examples of suitable transceivers include a radio set or more preferably a cellular phone connected to a wireless data connection, such as a local area wireless network. The transceiver 32 is connected to the controller 28. The transceiver 32 is capable of transmitting and receiving a position signal corresponding to positional information of the main vehicle 12 and/or the auxiliary vehicles 16. In the case of a cellular phone, the transceiver 32 transmits and receives the position signal via a cellular tower 35 connected with a cellular service provider.

The use of a cellular phone as the transceiver 32 is advantageous for a variety of reasons. Cellular phones have become quite common and are relatively inexpensive. The cellular phone can be used by the driver of the main vehicle for purposes other than navigational information, such as voice communication and also data communication. Modern digital cellular phones are capable of downloading and viewing web pages and other data information from the Internet. Cellular phones are also portable, enabling them to be used outside of the vehicle. The vehicle could be equipped with a docking station or cradle which permits removable electrical connection of the cellular phone to the controller 28.

As an alternative, the navigation unit 22, controller 22, and/or the display 30 may be integrated into a cellular phone which also functions as the transceiver 32. Thus, an integrated navigational/transceiver unit can be used for determining the position of the vehicle and also to transmit that positional information. This navigational/transceiver unit can be portable or mounted in the vehicle.

As stated before, the navigational unit 22 may use different position locating technologies other than GPS systems. For example, if the navigational system 14 is incorporated into a cellular phone, network based position locators using specialized cellular phone and land based equipment may be used. Suitable approaches include time difference of arrival, angle of arrival, and multipath analysis. In a time difference of arrival approach, clocks are used to determine the difference in time in which a signal reaches different land based cell sites or towers 35. This difference in time is then resolved to determine the position of the cellular phone and may compute the velocity and heading of the vehicle in which the cellular phone is in use. In an angle of arrival approach, the cellular towers include a directional antenna array. The direction of the cellular signal received at one or more towers is measured with respect to the antennas of known position to determine the position of the cellular phone. In the multipath analysis approach, the cellular network uses a multipath database on a location grid for specific service areas. The multipath database is used to match the cellular phone's signal characteristics to determine a point on the location grid. Thus, it should be understood that any suitable position location device can be used with the present invention for determining the location of a vehicle.

The auxiliary vehicles 16 may be similarly equipped as the main vehicle 12. Preferably, the auxiliary vehicles include at least a transmitter or transceiver 40 and navigation system 42 for relaying positional information of the auxiliary vehicle 16. The navigation system 42 includes a navigation unit 44 and a controller 46. As will be discussed below, the transceiver 40 transmits a position signal to the main vehicle and/or the land based navigation system 20 so that the position of the auxiliary vehicle 16 can be tracked.

Optionally, the navigation system 42 of the auxiliary vehicles 16 also includes a display 48 so that the position of the auxiliary vehicle 16 is displayed. Furthermore, the transceiver 40 and the controller 46 may be configured to receive a position signal corresponding to the location of the main vehicle and/or other auxiliary vehicles 16 so that their positions may also be displayed.

The transceiver 40, navigation unit 44, controller 46 and the display 48 may be similar in function and structure as the transceiver 32, navigation unit 22, controller 28, and display 30 of the main vehicle 12, as discussed above.

The land based navigation system 20 includes a controller 50, such as a microprocessor. Preferably, the navigation system 20 also includes a display 54 for displaying the position of the auxiliary and/or main vehicles 12 and 16. The display 54 can be any suitable display, such as a computer monitor, for displaying such information. It is preferred that the controller 50 and the display 54 are components of a computer system. The position signal of the auxiliary vehicles 16 and/or main vehicle 12 can be received by the land based navigation system 20 by any suitable manner. For example, the land based navigation system 20 may include a transceiver 52 for directly receiving a position signal transmitted by the transceivers 32 and/or 40. The land based navigation system 20 may receive the position signal via an interface with the Internet, as will be discussed in detail below.

The operation of the system 10 will now be described. In a first or simplified embodiment of the present invention, the auxiliary vehicles 16 are only equipped with a navigational receiving unit 44 and a wireless transmitter 44 for determining and relaying the positional information of the auxiliary vehicle 16. This positional information is preferably retrieved by navigational systems of both the main mobile navigation system 14 and the land based navigational system 20. The positional information is transmitted by the transceiver 40 from the auxiliary vehicle(s) 16. The navigational systems of the main mobile navigation system 14 and the land based navigational system 20 can retrieve the positional information by any suitable manner. For example, the navigational systems of both the main mobile navigation system 14 and the land based navigational system 20 may include transceivers 32 and 52, respectively, to directly receive a wireless position signal transmitted by the transceiver 40. That signal can then be decoded by the respective controller to display the position of the auxiliary vehicle 16 on the respective displays 30 and 54. If the transceivers 40 are cellular phones, the position signal is transmitted by the transceivers 40 to the tower 35 and corresponding cellular site. The cellular site is connected to a cellular network which then retransmits the position signal to the transceivers 32 and 52. The respective controllers 28 and 50 decode the position signal and display the position of the auxiliary vehicle 16 on the respective displays 30 and 54.

Instead of a direct wireless transmission of the position signal between the transceivers 32, 40, and 52, the position signal may be transmitted through the Internet. For example, the transceiver 40 of the auxiliary vehicle 16 may be a cellular phone having access to the Internet. The position signal transmitted by the transceiver 40 is either sent via the Internet directly from the cellular phone, or the position signal may be transmitted to the cellular network which is connected to a data service bureau, which then sends the data corresponding to the position signal over the Internet to a server computer. To access the data, the transceiver 32 of the main vehicle may interface with the Internet to retrieve the data. The controller 28 can then display the position of the auxiliary vehicle on the display 30. The data is also preferably decoded and loaded onto a computer database which is accessible to the land based navigation system 20 where the data is decoded and utilized in a software interface. The land based navigation system 20 is in communication with the database, such as through the controller 50 via the Internet. Thus, the land based navigational system 20 may simply be a personal computer connected to the Internet for obtaining the positional information of the auxiliary vehicle 16. Alternatively, the land based navigational system 20 can retrieve the position signal via the transceiver 52 in a similar manner as the transceiver 32 of the main vehicle as described above. If the positional information of the auxiliary vehicle 16 is obtainable over the Internet, other computers 60 may also access this positional information, such as via a web page interface. The web page interface may include security protocol to selectively permit viewing of the position data.

In another embodiment of the present invention, the main mobile navigational system 14 of the main vehicle 12 includes the navigational receiving unit 22 for detecting the location of the main vehicle 12 and preferably displaying this information on the display 30. Thus, the operator of the main vehicle 12 will be able to track the positions of the auxiliary vehicles 16 relative to the location of the main vehicle 12. Additionally, the land based navigation system 20 may also be configured to display the location of the auxiliary vehicles 16 along with the main vehicle 12.

In yet another alternate embodiment of the invention, one or more of the auxiliary vehicles 16 may include the navigational receiving unit 44 and the display 48 for displaying the positions of one or more of the main vehicle 12 and other vehicles 16 relative to its own position.

To reduce the transmission time of the transceivers 32, 40, and 52, the transmitted signals may be sent according to a time or event schedule. For example, the transceivers 32 and 40 may transmit their position signal at a predetermined time interval. In this manner, the number of calls and airtime that a cellular phone uses acting as the transceiver could be regulated to reduce the cost of using the cellular network. Additionally, the transceivers 32 and 40 may transmit their position signal upon receipt of a request transmission sent by the main vehicle 12 or the land based navigational system 20. Thus, in-between the predetermined time interval the operator of the main vehicle 12, the land based navigational system 20, or another auxiliary vehicle 16 may transmit a request signal to the transceivers 32 and 40 to transmit a current position signal.

It should be understood that the term transceiver as used throughout may be substituted for a transmitter or a receiver if the other function is not required. For example, if the auxiliary vehicles 16 do not include a display 48 for displaying their position, only a transmitter would be required for transmitting the position signal. Likewise, the transceivers 32 and 52 of the main vehicle 12 and the land based navigational system 20 may be receivers which do not include a transmitter function, if only the positional information of the auxiliary vehicles is to be tracked and displayed.

It should also be understood that the term cellular phone as used herein can be any phone, personal computer, PDA or other suitable device capable of transmitting and/or receiving cellular formatted signals to and from a cellular network.

In accordance with the provisions of the patent statutes, the principle and mode of operation of this invention have been explained and illustrated in its preferred embodiment. However, it must be understood that this invention may be practiced otherwise than as specifically explained and illustrated without departing from its spirit or scope.

What is claimed is:

1. A vehicle fleet navigation system comprising:
a main mobile navigation system mounted in a main vehicle including:
a navigation unit for determining the position of the main vehicle;
a visual display for displaying the position of the main vehicle; and
a wireless transceiver in communication with said navigation unit;
at least one secondary mobile navigation system mounted in a second vehicle including:
a second navigation unit for determining the position of the second vehicle;
a second wireless transceiver in communication with said second navigation unit, said second wireless transceiver operable to transmit a position signal corresponding to positional information of the second vehicle received from said second navigation unit, wherein said main mobile navigation system is operable to receive the positional information of the second vehicle and display the position of the second vehicle on said visual display; and
a land based navigation system in communication with one of said main mobile navigation system and said secondary mobile navigation system to receive the positional information of the second vehicle, wherein said land based navigation system includes a visual display for displaying the position of the second vehicle.

2. The system of claim 1, wherein at least one of the visual display of the main mobile navigation system and the visual display of the land based navigation system displays the position of the second vehicle on a pictorial map.

3. The system of claim 1, wherein said land based navigation system is in communication with said main mobile navigation system, and wherein said visual display of said land based navigation system is operable to display the position of the main vehicle on said pictorial map of said land based navigation system.

4. The system of claim 3, wherein said land based navigation system is in communication with said main mobile navigation system via said wireless transceiver of said main mobile navigation system.

5. The system of claim 4, wherein said land based navigation system includes a wireless receiver for directly communicating with said wireless transceiver of said main navigation system.

6. The system of claim 1, wherein said land based navigation system is in communication with said secondary mobile navigation system via said second wireless transceiver of said second navigation system.

7. The system of claim 6, wherein said land based navigation system includes a wireless receiver for directly communicating with said second wireless transceiver.

8. The system of claim 1, wherein said land based navigation system is in communication with one of said main mobile navigation system and said secondary mobile navigation system by a server.

9. The system of claim 8, wherein said server is an Internet server.

10. The system of claim 8, wherein said sever is accessed by a transceiver connected to local area wireless network.

11. The system of claim 1, wherein said land based navigation system is in communication with one of said main mobile navigation system and said second navigation unit by a third transceiver.

12. The system of claim 11, wherein said third transceiver is a cellular phone.

13. The system of claim 11, wherein said third transceiver is operable to receive a position signal indicative of the position of the second vehicle.

14. The system of claim 11, wherein said transceiver of said main mobile navigation system is in communication with said navigation unit for generating a position signal indicative of the position of the main vehicle, and wherein said third transceiver is operable to receive said position signal emitted from said transceiver of said main mobile navigation system.

15. The system of claim 1, wherein said transceiver and said second transceiver are operable to communicate with one another via a local area wireless network.

16. The system of claim 1, wherein one of said transceiver and said second transceiver is a cellular phone.

17. The system of claim 1, wherein said second transceiver is a cellular phone.

18. The system of claim 1, wherein said visual display and one of said transceiver and said second transceiver and are integrated together.

19. The system of claim 18, wherein said one of said transceiver and said second transceiver is in communication with the Internet, and wherein said pictorial map is received by said one of said transceiver and said second transceiver via web page over the Internet.

20. The system of claim 1, wherein one of the navigation unit and second navigation unit uses a global positioning system for determining the position of the corresponding vehicle.

21. The system of claim 1, wherein said secondary mobile navigation system includes a visual display for displaying the position of the second vehicle.

22. The system of claim 21, wherein said second navigation unit is operable to receive positional information of the main vehicle and display the position of the main vehicle on said display of said secondary mobile navigation system.

23. The system of claim 1, wherein said visual display displays a symbol representative of the position of said second vehicle overlaid on a pictorial map.

24. The system of claim 1, wherein a plurality of position signals are transmitted at spaced apart time intervals to update the positional information of the second vehicle.

25. The system of claim 24, wherein the plurality of signals are transmitted according to a time schedule.

26. The system of claim 24, wherein the plurality of signals are transmitted according to the occurrence of an event.
